(19) United States
(12) Patent Application Publication
(10) Pub. No.: US 2025/0214151 A1
(43) Pub. Date: Jul. 3, 2025

(54) UNIVERSAL CLAMPING SYSTEM, CLAMPING ADAPTER, MACHINE ELEMENT, PROCESSING AND/OR MEASURING MACHINE AND METHOD OF CLAMPING AND RELEASING

(71) Applicant: Franz Haimer Maschinenbau KG, Hollenbach-Igenhausen (DE)

(72) Inventor: Franz Haimer, Hollenbach-Igenhausen (DE)

(21) Appl. No.: 19/003,070

(22) Filed: Dec. 27, 2024

(30) Foreign Application Priority Data
Dec. 27, 2023 (DE) 10 2023 136 700.5

(51) Int. Cl. B23B 31/10

(52) U.S. Cl. CPC B23B 31/102

(57) ABSTRACT

A clamping adapter for clamping a component provides that during the clamping or releasing of the component on a clamping adapter by actuation of a clamping mechanism which has a first clamping device for clamping or releasing the component on the clamping adapter and a second clamping device for clamping or releasing the clamping adapter on the machine element, the clamping adapter itself can also be clamped or released on the machine element by the actuation of the clamping mechanism. A machine element for clamping a clamping adapter that can clamp a component, clamping systems for clamping a component on a machine element of a processing and/or measuring machine, and a processing and/or measuring machine for processing and/or measuring a component, as well as methods for clamping or releasing a component on a machine element of a processing and/or measuring machine, are also provided.

### CROSS-REFERENCE TO RELATED APPLICATION

This application claims the priority, under 35 U.S.C. § 119, of German Patent Application DE 10 2023 136 700.5, filed Dec. 27, 2023; the prior application is herewith incorporated by reference in its entirety.

### FIELD AND BACKGROUND OF THE INVENTION

The invention relates to a clamping adapter for clamping a component, a machine element for clamping a clamping adapter that can clamp a component, clamping systems for clamping a component on a machine element of a processing and/or measuring machine, and a processing and/or measuring machine for processing and/or measuring a component, as well as methods for clamping or releasing a component on a machine element of a processing and/or measuring machine.

German Patent Application DE 10 2019 124 418 A1, corresponding to U.S. Pat. No. 11,602,794 B2, discloses subject matter of the type in question, such as a clamping adapter of the type in question for clamping a component, and clamping systems of the type in question having such a clamping adapter and a machine element that receives the clamping adapter.

That clamping adapter for clamping a component, more specifically in that case a balancing adapter, i.e. a clamping adapter for clamping components/workpieces to be balanced, e.g. milling tools, tool holders or belt pulleys, on a balancing machine, provides a (clamping-adapter) housing part, a clamping device, which is mounted in the (clamping-adapter) housing part and can clamp the component, and a first actuating element, which can actuate the clamping device.

Moreover, German Patent Application DE 10 2019 124 418 A1, corresponding to U.S. Pat. No. 11,602,794 B2, also shows the machine element, that is to say in that case a drive spindle of the balancing machine, with a (machine-element) housing part, an actuating device mounted in the (machine-element) housing part, and a second actuating element, which can actuate the actuating device.

In order to clamp the workpiece to be balanced, the balancing adapter is screwed to the (machine-element) housing part. The first and the second actuating element are likewise screwed together. Due to actuation of the actuating device by the second actuating element, the first clamping device clamps—via the first and the connected second actuating element—the component to be balanced.

The disadvantage with that clamping system, including a clamping adapter and a machine element, in German Patent Application DE 10 2019 124 418 A1, corresponding to U.S. Pat. No. 11,602,794 B2, is that, even before clamping a component, the clamping adapter that receives the component must already be firmly mounted in the machine element (in that case screwed in) and that after the release of the component from its clamping in the clamping adapter, the clamping adapter is still firmly mounted in the machine element.

That has the further disadvantage that reset times are extended and a degree of automation is reduced, since processing processes with changing components and thus adapted, changing, clamping adapters generally require a reset of clamping adapters (there, in the case of German Patent Application DE 10 2019 124 418 A1, corresponding to U.S. Pat. No. 11,602,794 B2, due to the release that is required there of the screw connection and repeated screwing in of the clamping adapter (again)).

An improvement is provided by a clamping system including a balancing adapter or clamping adapter and machine element, from German Patent Application DE 10 2007 036 144 A1, corresponding to U.S. Pat. No. 9,180,527 B2.

There, the clamping adapter—likewise—provides a balancing adapter of a clamping system including a balancing adapter that clamps a component to be balanced and a drive spindle (machine element) that receives the clamping adapter—a (clamping-adapter) housing part, a clamping device, which is mounted in the (clamping-adapter) housing part and can clamp the component, and a first actuating element, which can actuate the clamping device.

Moreover, German Patent Application DE 10 2007 036 144 A1, corresponding to U.S. Pat. No. 9,180,527 B2, also shows a machine element, that is to say in that case once again a drive spindle of a balancing machine, with a (machine-element) housing part, an actuating device mounted in the (machine-element) housing part, and a second actuating element, which can actuate the actuating device.

In that case, to clamp the workpiece to be balanced, the balancing adapter is once again screwed to the (machine-element) housing part. The first and the second actuating element are likewise connected to one another—there—via a coupling with a bayonet joint. Due to actuation of the actuating device by the second actuating element, the first clamping device clamps-via the first and the connected second actuating element—the component to be balanced.

However, to enable the balancing or clamping adapter to be changed more quickly there, German Patent Application DE 10 2007 036 144 A1, corresponding to U.S. Pat. No. 9,180,527 B2, then envisages that the (clamping-adapter) housing is of two-part configuration, namely a main body, which can be screwed to the drive spindle or the machine element, and an interchangeable body which clamps the component to be balanced.

According to German Patent Application DE 10 2007 036 144 A1, corresponding to U.S. Pat. No. 9,180,527 B2, the interchangeable body can be decoupled from the main body and removed (without having to release the screw fastening of the main body) (or vice versa) in order to swap it for a corresponding different interchangeable body—for other components to be balanced. In German Patent Application DE 10 2007 036 144 A1, corresponding to U.S. Pat. No. 9,180,527 B2, that thus enables quicker reset times and a higher degree of automation.

### SUMMARY OF THE INVENTION

It is accordingly an object of the invention to provide a universal clamping system, a clamping adapter, a machine element, a processing and/or measuring machine and a method of clamping and releasing, which overcome the hereinafore-mentioned disadvantages of the heretofore-known devices and methods of this general type and which further improve, in particular simplify, the clamping adapters or clamping systems known in the prior art and enable simple and yet accurately positioned, safe and reproducible mounting and retention of a component to be clamped as well as quick reset times and a high degree of automation.

With the foregoing and other objects in view there is provided, in accordance with the invention, a clamping adapter for clamping a component, having a (clamping-adapter) housing part, a first clamping device, which is mounted in the (clamping-adapter) housing part and can clamp the component, and a first actuating element, which can actuate the first clamping device, the first actuating element having clamping-function surfaces, via which the first actuating element can be coupled or released—by using a second clamping device of a machine element of a processing and/or measuring machine—to or from a second actuating element—which can actuate the second clamping device—when the second actuating element is actuated, whereby the first actuating element can then be actuated by the second actuating element and, in this case, when the second actuating element is actuated, the clamping adapter can also be clamped on or released from the machine element.

This object is achieved by a clamping adapter for clamping a component, a machine element for clamping a clamping adapter that can clamp a component, clamping systems for clamping a component on a machine element of a processing and/or measuring machine, and a processing and/or measuring machine for processing and/or measuring a component, as well as methods for clamping or releasing a component on a machine element of a processing and/or measuring machine, having the features recited above.

Advantageous further developments of the invention form the subject matter of dependent claims and of the following description—and relate to the clamping adapter for clamping a component, the machine element for clamping a clamping adapter that can clamp a component, the clamping systems for clamping a component on a machine element of a processing and/or measuring machine, and the processing and/or measuring machine for processing and/or measuring a component, as well as to the methods for clamping or releasing a component on a machine element of a processing and/or measuring machine.

Terms such as “top,” “bottom,” “front,” “rear,” “left” or “right” that may be used should be understood in the usual sense, unless explicitly defined otherwise. Where they are used and not otherwise explicitly defined, terms such as “radial” and “axial” should be understood in relation to central axes or axes of symmetry of component parts/components described here.

Where used, the term “substantially” can be understood (in a strictly juridical sense) as referring to “a degree that is still significant in practice.” Possible deviations from precision that are thus implied by this terminology may therefore arise unintentionally (i.e. for no functional reason) due to manufacturing or assembly tolerances or the like.

### Subject Matter of the Invention

The clamping adapter for clamping a component provides a (clamping-adapter) housing part, a first clamping device, which is mounted in the (clamping-adapter) housing part and can clamp the component, and a first actuating element, which can actuate the first clamping device.

Furthermore, the clamping adapter provides that the first actuating element has clamping-function surfaces, via which the first actuating element can be coupled or released—by using a second clamping device of a machine element of a processing and/or measuring machine—to or from a second actuating element—which can actuate the second clamping device-when the second actuating element is actuated.

In this way, the first actuating element can then be actuated by using the second actuating element—wherein in this way, when the second actuating element is actuated, the clamping adapter can also be clamped on or released from the machine element.

The machine element for clamping a clamping adapter that can clamp a component, in particular for clamping the clamping adapter, provides a (machine-element) housing part, a second clamping device, which is mounted in the (machine-element) housing part and through the use of which a first actuating element of a first clamping device of the clamping adapter that can clamp a component can be clamped or released, and a second actuating element that can actuate the second clamping device.

In this way, the first actuating element can then be actuated by using the second actuating element—wherein in this case/when the second actuating element is actuated, the clamping adapter can also be clamped on or released from the machine element.

The clamping system for clamping a component on a machine element of a processing and/or measuring machine provides a clamping adapter, in particular the clamping adapter, and a machine element, in particular the machine element.

The clamping adapter has a (clamping-adapter) housing part, a first clamping device, which is mounted in the (clamping-adapter) housing part and can clamp the component, and a first actuating element, which can actuate the first clamping device. The machine element has a (machine-element) housing part, a second clamping device, which is mounted in the (machine-element) housing part, and a second actuating element, which can actuate the second clamping device.

The first actuating element can be coupled to or released from the second actuating element in such a way—when the second actuating element is actuated—that—when the second actuating element is actuated—both the component in the clamping adapter and the clamping adapter on the machine element can be clamped or released.

The further clamping system according to the invention for clamping a component on a machine element of a processing and/or measuring machine also has a clamping adapter, in particular the clamping adapter, and also a machine element, in particular the machine element.

The clamping adapter has a (clamping-adapter) housing part, a first clamping device, which is mounted in the (clamping-adapter) housing part and can clamp the component, and a first actuating element, which can actuate the first clamping device. The machine element has a (machine-element) housing part, a second clamping device, which is mounted in the (machine-element) housing part, and a second actuating element, which can actuate the second clamping device.

The first actuating element can be coupled to the second actuating element in such a way—by actuation of the second actuating element—that when the second actuating element is actuated-both the first actuating element and the second actuating element can be actuated, in particular can be moved axially, and thus the component can be clamped on the clamping adapter by using the first clamping device.

The—again—further clamping system according to the invention for clamping a component on a machine element of a processing and/or measuring machine also has a clamping adapter, in particular the clamping adapter, and also a machine element, in particular the machine element.

The clamping adapter has a (clamping-adapter) housing part, a first clamping device, which is mounted in the (clamping-adapter) housing part and can clamp the component, and a first actuating element, which can actuate the first clamping device. The machine element has a (machine-element) housing part, a second clamping device, which is mounted in the (machine-element) housing part, and a second actuating element, which can actuate the second clamping device.

The first actuating element provides clamping-function surfaces, via which the first actuating element can be coupled or released—by using the second clamping device—to or from the second actuating element—which actuates the second clamping device—when the second actuating element is actuated, whereby—when the second actuating element is actuated—both the component in the clamping adapter and the clamping adapter on the machine element can be clamped or released.

The—also—further clamping system according to the invention for clamping a component on a machine element of a processing and/or measuring machine also has a clamping adapter, in particular the clamping adapter, and also a machine element, in particular the machine element.

The clamping adapter has a (clamping-adapter) housing part, a first clamping device, which is mounted in the (clamping-adapter) housing part and can clamp the component, and a first actuating element, which can actuate the first clamping device. The machine element has a (machine-element) housing part, a second clamping device, which is mounted in the (machine-element) housing part, and a second actuating element, which can actuate the second clamping device.

The first actuating element provides clamping-function surfaces, via which the first actuating element can be coupled or released—by using the second clamping device—to or from the second actuating element—which actuates the second clamping device—when the second actuating element is actuated, whereby—when the second actuating element is actuated—both the first actuating element and the second actuating element can be actuated, in particular can be moved axially, and thus the component can be clamped on the clamping adapter by using the first clamping device.

The processing and/or measuring machine for processing and/or measuring a component has a clamping adapter and a machine element, in particular the clamping adapter and the machine element, and/or a clamping system, in particular the clamping system.

The component can thus be clamped on the machine element of the processing machine by using the clamping adapter or of the clamping system during the processing and/or measurement.

According to the method for clamping or releasing a component on a machine element of a processing and/or measuring machine by using a clamping mechanism, in particular using a clamping adapter, a machine element, a clamping system and/or a processing and/or measuring machine, in particular the clamping adapter, the machine element, the clamping system and/or the processing and/or measuring machine, it is envisaged that, during the clamping or release of the component on a clamping adapter by actuation of the clamping mechanism, the clamping adapter itself can also be clamped or released on a machine element of the processing machine by the actuation of the clamping mechanism.

According to the method for clamping or releasing a component on a machine element of a processing and/or measuring machine by a clamping mechanism, in particular using a clamping adapter, a machine element, a clamping system and/or a processing and/or measuring machine, in particular the clamping adapter, the machine element, the clamping system and/or the processing and/or measuring machine, it is envisaged that a or the first actuating element, which can actuate a or the first clamping device for clamping or releasing the component on the clamping adapter, can be coupled to a or the second actuating element, which can actuate a or the second clamping device for clamping or releasing the clamping adapter on the machine element, in this way—by actuation of the second actuating element—and then—when the second actuating element is actuated—both the first actuating element and the second actuating element can be actuated, in particular can be moved axially, and, in the process, the component can be clamped on the clamping adapter by using the first clamping mechanism.

The subjects according to the invention are based on the consideration that the two clamping devices, namely a first for clamping or releasing the component on the clamping adapter and the other, second, for clamping or releasing the clamping adapter on the machine element, can be coupled in such a way—via the clamping-function surfaces on the first actuating element of the first clamping device (and thus the clamping mechanism of the second clamping device)—that, when the second clamping device or second actuating element is actuated, both clamping devices can also be clamped or released by one actuation/movement.

Thus, in or by this “one” actuation (of the second actuating element or the second clamping device)—it is possible to clamp and re-release both the clamping adapter (on the machine element) and the component (on the clamping adapter).

Thus, both of them, that is to say the component and the clamping adapter, can be freed and removed or fixed and clamped (in this one actuation). Additional and separate process steps for securing the clamping adapter on the machine element and/or for firmly coupling the fastening elements, such as by screw fastening in the prior art, are eliminated.

Irrespective of this, there may furthermore also be provision of measures which continue to secure the components that have been freed/released or are freed/can be released by using the invention, i.e. the component to be clamped and the clamping adapter, e.g. against unintentional falling out or release.

Thus, for example, a—subsequently described—holding and/or locking device, optionally secured on a machine-element housing/part—using which the clamping adapter can be held locked in the (machine-element) housing part, and/or a screwed joint, using which the clamping adapter can be screwed to the (machine-element) housing part. Irrespective of whether a clamping adapter has been freed or released by using the invention, this adapter can thus be held on the machine element. This also enables the component to be clamped and the clamping adapter to be changed as a unit without the risk that the component will be released from the clamping adapter.

Another example being a—subsequently described—first brace (on the clamping adapter), which braces the first actuating element against the (clamping-adapter) housing part.

The first brace—if directed counter to the release or release actuation/release actuation direction (i.e. if it (pre-) loads the first clamping device)—can in this way ensure that-even in the case of the release actuation according to the invention or of the second actuating element—the first clamping device continues to be clamped—and the component to be clamped remains clamped/held on the clamping adapter.

If, however, the first brace is directed counter to the clamping or the clamping actuation/clamping actuation direction (i.e. if it releases the first clamping device), it is thereby possible to transmit a clamping actuation force (by actuation of the second actuating element) to the component to be clamped in a manner that is “metered” (via the strength of the first brace).

Returning to the invention—expressed in a clear and simple way in the case of the invention: an actuating movement, namely the actuation of the second actuating element is sufficient or initiates the coupling (or conversely the decoupling) of the two actuating elements, as well as the clamping (or conversely the release) both of the clamping adapter on the machine element and of the component on the clamping adapter.

The invention thereby achieves significant advantages, namely that one actuating step is sufficient to quickly reset the processing or measuring machines. The degree of automation of these machines can thereby be increased. The invention thus enables efficient and effective processing processes.

Moreover, such clamping devices or systems can be implemented in a simple and low-cost manner, and they also enable safe and accurately positioned clamping, and therefore the invention also enables accurately positioned, safe and reproducible reception and retention of a component to be clamped on a processing or measuring machine in a simple and low-cost manner.

### Dependent Subject Matter of the Invention

The clamping adapter can furthermore also provide for the first clamping device to have a first collet, in particular with a first sleeve-shaped base and/or a plurality of radially resilient first clamping tongues separated from one another in the circumferential direction by axial slots, attached to the first sleeve-shaped base and having a front, first clamping region assigned to the component to be clamped.

It is also possible for rear slots aligned axially with the front slots to be disposed in the first sleeve-shaped base.

The clamping adapter can furthermore also provide for the first clamping device to have a first collet with a plurality of separate first clamping tongues that can be disposed in a manner distributed in the circumferential direction and have a front, first clamping region assigned to the component to be clamped. In particular, it is possible in this way for four, five, six, seven or eight first clamping tongues to be provided, for example.

These can expediently be disposed in a ring shape and/or centrically around the first actuating element.

Provision may furthermore also be made for the sleeve-shaped base or the separate clamping tongues to be held in the (clamping-adapter) housing part. This is expedient particularly when the component to be clamped has a hollow shank taper interface.

Other interfaces on the component may make it necessary for clamping elements of similar or different configuration, e.g. a clamping sleeve, to be provided instead of the first collet, and these will then also be disposed in a different location in or on the (clamping-adapter) housing element.

In particular, however, it is expedient if first clamping claws that can clamp the component are formed in the front, first clamping region of the first clamping tongues or of the first collet.

The first clamping claws can expediently have radially outer form-locking elements, e.g. specially configured geometrical contours, this again being of significance, especially in this case too, if the component to be clamped has a hollow shank taper interface.

Here too, other interfaces on the component may make it necessary for the form-locking elements to be of different configuration or configured in a differently adapted way and or to be at a different location, e.g. radially on the inside.

It furthermore also proves expedient if the first actuating element is of multi-part configuration with a plurality of, in particular at least two, actuating sub-elements that can be connected or coupled, in particular screwed, to one another, and are optionally configured as tie rods.

Provision may also be made for the first actuating element or the actuating sub-elements or tie rods of the first actuating element to be mounted in the (clamping-adapter) housing part in such a way as to be movable relative to the (clamping-adapter) housing part and axially.

Considered more simply and clearly: depending on direction, the axial movement initiates clamping or release in the first clamping device.

Furthermore, the first actuating sub-element can also have contact surfaces for guiding the first clamping device or the first clamping tongues of the first collet, in particular radially outer contact surfaces acting as a first guide track for the first clamping device or the first clamping tongues of the first collet.

Through the use of a geometrical configuration of the first contact surfaces or of the first guide track and/or a location of formation of the first contact surfaces or of the first guide track on the first actuating sub-element, it is possible to influence the clamping (or release) process both in terms of time and in terms of procedure/progress and in terms of clamping force.

Thus, it is advantageous, in particular, if the first guide track or the first contact surfaces is/are configured in such a way that-upon contact with the first clamping tongues of the first collet—these are moved radially, at least in some region or regions, in particular in the first clamping region, thereby enabling the first clamping claws, in particular, to be brought into form-locking engagement with the component to be clamped.

Provision may also be made to provide the first guide track or the first contact surfaces thereof optionally on the (clamping-adapter) housing part. However, if these interact with the first collet or the first clamping tongues/first clamping claws thereof, these must then be provided in a correspondingly different or adapted form.

It is furthermore advantageous if the second actuating sub-element, in particular in an end region, forms the clamping-function surfaces, configured, in particular, in the form of a knob or on an outer surface of a knob. Secure gripping or clamping is thereby facilitated or promoted.

A different configuration of the clamping-function surfaces is conceivable, e.g. recesses and/or undercuts, provided they do not hinder the clamping form-locking with the second actuating element, in particular relevant clamping tongues or clamping claws or form-locking elements.

It is also expedient if the first actuating element, in particular the second actuating sub-element, has a stop element, which can be brought into contact with the (clamping-adapter) housing part when the first actuating element is actuated—and, in the process, can optionally move the housing part axially. Such a stop element can, in particular and by way of example, be configured as a planar element in order in this way—in the case of contact—as far as possible to ensure surface contact—in particular with uniform surface loading.

In particular, it may also be expedient to use such a stop element also in the context of the already mentioned and then more specifically described first brace—e.g. as a support for a spring element.

It is also possible to provide a first centering element, in particular a sleeve-shaped centering element, in particular a centering element mounted in a receiving opening of the (clamping-adapter) housing part, for centered mounting of the component to be clamped, in particular of an entire tool having a conical interface, e.g. a bearing bush, on the clamping adapter.

It may also be expedient to provide a or the (already mentioned) first brace, in particular having a bracing element, e.g. a spring element, which braces the first actuating element against the (clamping-adapter) housing part.

In this case, such a bracing element or such a spring element can be disposed—functionally and so as to act—between the first actuating element and the (clamping-adapter) housing part.

It is furthermore particularly advantageous if a first bracing force of the first brace is selected in accordance with the component to be clamped.

The machine element can also provide for the second clamping device to have a second collet, in particular with a second sleeve-shaped base and/or a plurality of radially resilient second clamping tongues separated from one another in the circumferential direction by axial slots, attached to the second sleeve-shaped base and having a front, second clamping region assigned to the first actuating element to be clamped.

It is also possible for rear slots aligned axially with the front slots to be disposed in the first sleeve-shaped base.

However, the machine element can provide for the second clamping device to have a second collet with a plurality of separate second clamping tongues that can be disposed in a manner distributed in the circumferential direction and have a second clamping region assigned to the clamping-function elements to be clamped.

In particular, it is possible in this way for four, five, six, seven or eight second clamping tongues to be provided, for example.

These can expediently also be disposed in a ring shape and/or centrically around the second actuating element.

It furthermore appears expedient if second clamping claws that can clamp the first actuating element, in particular having form-locking elements for form-locking to the clamping-function surfaces of the first actuating element, e.g. specially configured geometrical contours, are—also—formed in the front, second clamping region.

It may also be expedient here if the second clamping tongues are held braced against the second actuating element, in particular using a load application element, in particular an annular spring.

In the case of the second actuating element too, it may be advantageous if the element is of multi-part configuration with a plurality of, in particular at least two, actuating sub-elements that can be connected or coupled to one another, in particular screwed together.

Provision may furthermore be made for the (machine-element) housing part to have second contact surfaces for guiding the second clamping device or the second clamping tongues of the second collet, in particular radially inner contact surfaces acting as a second guide track for the second clamping device or the second clamping tongues of the second collet.

Here too-Through the use of a geometrical configuration of the second contact surfaces or of the second guide track and/or a location of formation of the second contact surfaces or of the second guide track on the first actuating sub-element—it is possible to influence the clamping (or release) process both in terms of time and in terms of procedure/progress and in terms of clamping force.

Thus, here too, it is advantageous, in particular, if the second guide track or the second contact surfaces is/are configured in such a way that—upon contact with the second clamping tongues of the second collet—these are moved radially, at least in some region or regions, in particular in the second clamping region, thereby enabling the second clamping claws, in particular, to be brought into form-locking engagement with the clamping-function surfaces of the first actuating element.

Provision may also be made to provide the first guide track or the second contact surfaces thereof optionally on the second actuating element. However, if these interact with the second collet or the second clamping tongues/second clamping claws thereof, these must then be provided in a correspondingly different or adapted form.

It is also advantageous if the second actuating element is mounted in the (machine-element) housing part in such a way as to be movable relative to the (machine-element) housing part and axially.

Considered more simply and clearly: depending on direction, the axial movement initiates clamping or release in the second clamping device.

As a further development, the machine element can provide a machine-element housing, in which the (machine-element) housing part is received or mounted, in particular using rolling bearings, in particular rotatably (cf. lathe spindle).

It is also possible to provide a or the already mentioned holding and/or locking device, using which the clamping adapter can be held locked in the (machine-element) housing part, and/or a screwed joint, using which the clamping adapter can be screwed to the (machine-element) housing part.

This holding and/or locking device is expediently secured on the machine-element housing or on the (machine-element) housing part.

Provision may also be made for the holding and/or locking device to be mechanically actuatable, wherein, in particular during actuation, the clamping adapter can be held locked by form-locking in the (machine-element) housing part.

In the case of the machine element, a centering element, i.e. the second centering element, can furthermore likewise be provided. It appears expedient if the second centering element provides a ball cage, in particular a ball cage mounted in a receiving opening of the (machine-element) housing part, for centered mounting of the clamping adapter on the machine element.

As a further development, the machine element can have a second brace, in particular a brace acting with or counter to the first brace, in particular having a bracing element, in particular a spring element, e.g. a compression spring, which braces the second actuating element, in particular the second actuating sub-element thereof, against the (machine-element) housing part.

This second brace can expediently have a bracing element, in particular a spring element, which is disposed functionally and so as to act between the second actuating element, in particular the second actuating sub-element thereof, and the (machine-element) housing part.

In addition, it is furthermore expedient here if the first bracing force of the first brace and a second bracing force of the second brace are matched to one another, in particular in consideration of the component to be braced.

In this case, the first bracing force of the first brace and the second bracing force of the second brace can be configured to act in such a way that they act in the same direction—or alternatively—the first bracing force of the first brace and the second bracing force of the second brace can be configured to act in such a way that they counteract one another.

It is furthermore also possible to provide a device, in particular a device that can be operated pneumatically or hydraulically or mechanically, which is mounted in the (machine-element) housing part and through the use of which the second actuating element can be moved for clamping and/or release.

Here, provision can furthermore also be made for the device to move the second actuating element in a controlled manner.

It also appears to be particularly advantageous if the second brace and the device are configured and matched to one another in such a way that a movement force of the device, in particular a pneumatically or hydraulically or mechanically applied movement force, acts counter to the second bracing force.

As a further development, it is expedient if the clamping and release of the clamping adapter and of the component take place sequentially during the actuation of the clamping mechanism and during the actuation of the second actuating element.

Alternatively, provision may also be made here for the clamping and release of the clamping adapter and of the component to take place simultaneously during the actuation of the clamping mechanism and during the actuation of the second actuating element.

Temporal processes configured in this way can be achieved or implemented, in particular, by appropriate arrangement (e.g. axial spacing) of the first and second track or an axial length of the actuating elements/actuating sub-elements.

A further development advantageously envisages that, during the actuation of the clamping mechanism and during the actuation of the second actuating element, the release of the component clamped on the clamping adapter is prevented, in particular using a or the first brace (see above), or the release of the clamping adapter clamped on the machine element is prevented, in particular using a or the holding and/or locking device (see above).

It is also possible to envisage that, during the actuation of the clamping mechanism and during the actuation of the second actuating element, the component is moved axially relative to the (clamping-adapter) housing part and/or the clamping adapter is moved axially relative to the (machine-element) housing part.

Automated “ejection” of the corresponding part can be achieved or facilitated in this way.

### Method Phases

In an advantageous further development, it is envisaged that, during clamping by actuation of the second actuating element, in particular by the axial movement thereof relative to the (machine-element) housing part in a pull-in/clamping direction, the second clamping device clamps or grips the first actuating element in a first clamping phase.

Furthermore, it is then possible, during clamping by actuation of the second actuating element, in particular by the axial movement thereof relative to the (machine-element) housing part in the pull-in/clamping direction, in a second clamping phase following the first, for the first actuating element, which is clamped by the second clamping device, likewise to be moved axially in the pull-in/clamping direction of the second actuating element (if the first actuating element has been clamped by the second clamping device in the first clamping phase).

It is expedient if, in this second clamping phase, the component to be clamped is clamped on the clamping adapter by using the first clamping device actuated by the first actuating element—and then, by further actuation of the second actuating element, in particular by the axial movement thereof relative to the (machine-element) housing part in the pull-in/clamping direction, the clamping adapter is clamped on the machine element.

If—in the case of an already mentioned pre-clamping of the component to be clamped on the clamping adapter, in particular by using the abovementioned first brace of the first clamping device, —the component to be braced is already braced on the clamping adapter, it may be expedient here, in particular, if, in this second clamping phase, in which the component to be clamped is already pre-braced on the clamping adapter by the first clamping device, the clamping adapter is clamped on the machine element.

Clamping of the component to be clamped on the clamping adapter by using the first clamping device is then no longer necessary here (since it has already taken place); any clamping forces on the component by actuation of the second actuating element in fact reinforce the first brace.

In another advantageous development, it is envisaged that, during release by actuation of the second actuating element (in this case, the first and the second actuating element are first of all coupled by using the clamped second clamping device), in particular by the axial movement thereof relative to the (machine-element) housing part in a release direction, the first actuating element and the second actuating element are moved axially in the release direction, as a result of which initially only the component clamped on the clamping adapter is released or freed (by release of the first clamping device, whereas the second clamping device is still held clamped) and only then is the clamping adapter clamped on the machine element released or freed—by release of the second clamping device.

However, it may also be expedient if, during release by actuation of the second actuating element (in this case, the first and the second actuating element are first of all coupled by using the clamped second clamping device), in particular by the axial movement thereof relative to the (machine-element) housing part in a release direction, the second actuating element is moved axially in the release direction, as a result of which the clamping adapter clamped on the machine element is released or freed. Any release or freeing in the case of the first clamping device can be counteracted or prevented by using the first brace mentioned.

A multiplicity of options in the coordination of the tracks/contact surfaces and actuating elements—in each case among or within and/or between these, and the possibility of refining the first brace in the clamping adapter (cf. also the direction of action of the first brace in the clamping adapter) thus allows a multiplicity of different clamping and release sequences with corresponding clamping or release phases.

The processing and/or measuring machine can be, for example, a machine tool, e.g. a milling, grinding or turning machine, a balancing device, a measuring device, a pre-adjustment device or a device for manufacture and/or forming and/or measuring the component to be clamped.

This then provides the clamping adapter for clamping a component or the machine element for clamping a clamping adapter that can clamp a component, or the clamping systems for clamping a component on a machine element of a processing and/or measuring machine—and carries out the method or methods for clamping a component on a machine element of a processing and/or measuring machine.

It also appears to be particularly advantageous here if the clamping adapter is a balancing or measuring adapter, or if the component to be clamped is a tool (in the sense of an overall tool including a tool holder, in particular with a steep taper, and an actual tool) or a workpiece to be processed, in particular by the processing or measuring machine.

The description given hitherto of advantageous configurations of the invention contains numerous features which are reproduced, in some cases with several combined together, in the individual dependent claims. However, these features may also expediently be considered individually and combined to form worthwhile additional combinations.

Even if some terms are used in the singular or in combination with a numeral in the description and in the patent claims, the scope of the invention as regards these terms should not be restricted to the singular or the respective numeral. Moreover, the words “a” and “an” should not be understood as numerals but as indefinite articles.

The properties, features and advantages of the invention which are described above and the manner in which these are achieved will become more clearly and distinctly intelligible in combination with the following description of the exemplary embodiments of the invention, which are explained in greater detail in combination with the drawings/figures (identical component parts/components and functions have the same reference signs in the drawings/figures and—for the sake of clarity—may not be inserted in all the figures).

The exemplary embodiments serve to explain the invention and do not limit the invention to the combination of features indicated therein, including with respect to functional features. Moreover, for this purpose, suitable features of any exemplary embodiment may also be considered explicitly in isolation, removed from one exemplary embodiment, introduced into another exemplary embodiment to complete it and/or combined with any of the claims.

Other features which are considered as characteristic for the invention are set forth in the appended claims.

Although the invention is illustrated and described herein as embodied in a universal clamping system, a clamping adapter, a machine element, a processing and/or measuring machine and a method of clamping and releasing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, vertical-sectional view of a balancing adapter according to a first embodiment of the invention, which is mounted in a balancing machine spindle and holds a tool holder (with a hollow shank taper interface), in a first (end) position;

FIG. 2 is a vertical-sectional view of the balancing adapter according to the first embodiment of the invention in a second (intermediate) position;

FIG. 3 is a vertical-sectional view of the balancing adapter according to the first embodiment of the invention in a third (end) position;

FIG. 4 is a vertical-sectional view of a balancing adapter according to a second embodiment of the invention, which is mounted in a balancing machine spindle and holds a tool holder (with a hollow shank taper interface), in a first (end) position; and

FIG. 5 is a vertical-sectional view of the balancing adapter according to the second embodiment of the invention in a second (end) position.

### DETAILED DESCRIPTION OF THE INVENTION

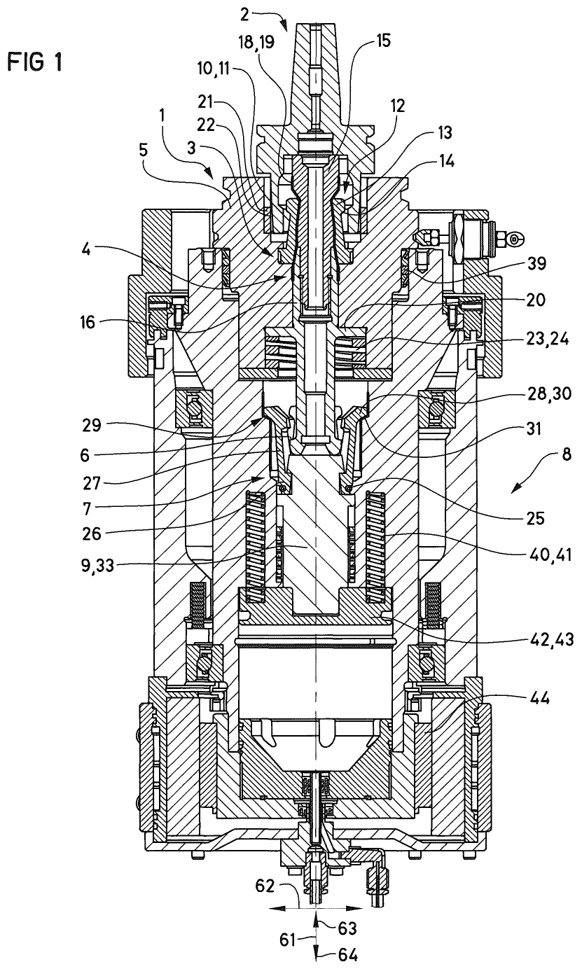

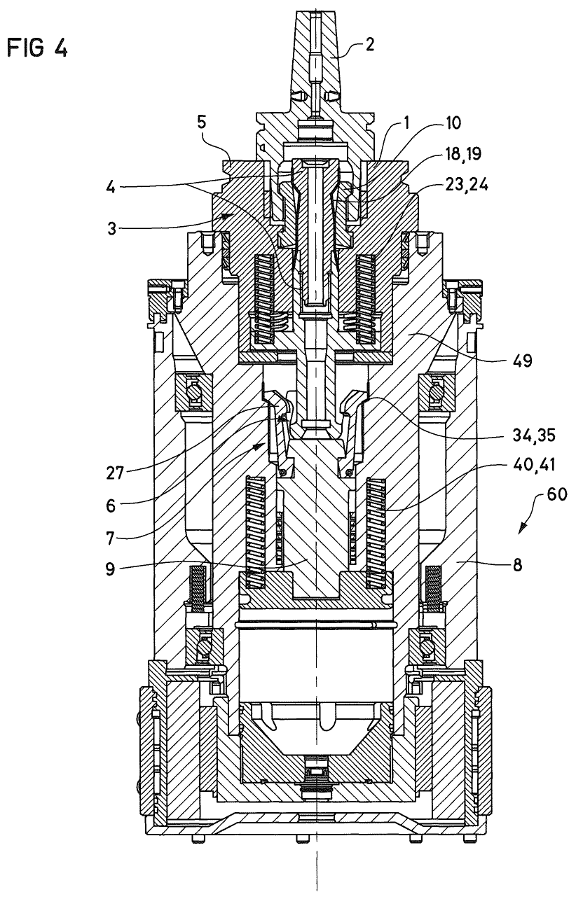

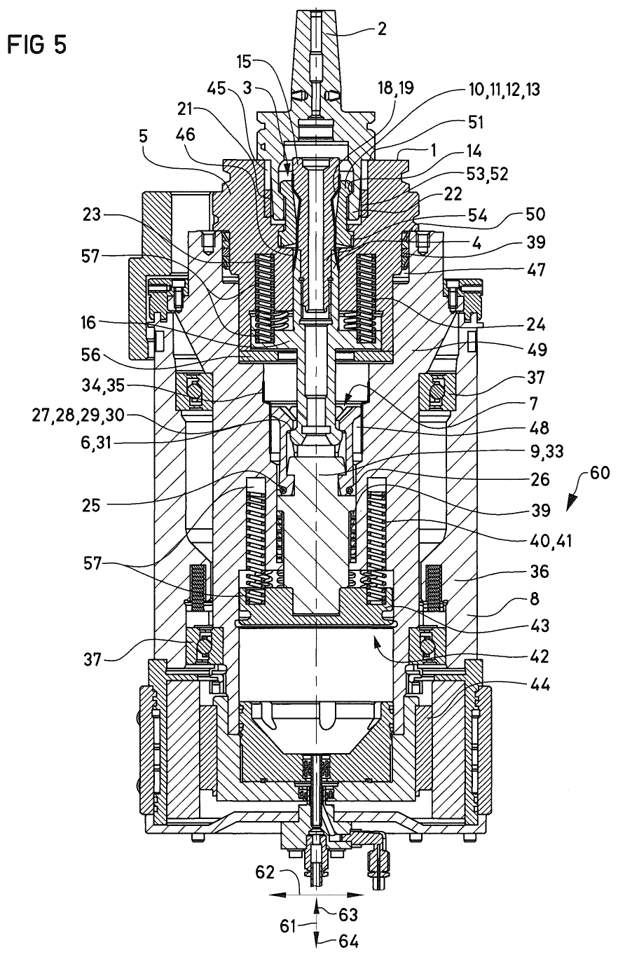

Referring now to the figures of the drawings in detail, there is seen a first embodiment of a universal clamping or balancing adapter in FIGS. 1-3, and a second embodiment thereof in FIGS. 4 to 5.

FIGS. 1 to 3 and FIGS. 4 to 5 respectively show a first and a second balancing adapter 1—mounted in a balancing machine spindle 8 of a balancing device 60—with a tool holder 2 (having a hollow shank taper interface 22) held in the balancing adapter 1.

The balancing adapters 1 shown are configured for clamping a rotating component 2, i.e. the tool holder 2 shown, here with a hollow shank taper interface 22, on the balancing machine spindle 8 of the balancing machine 60.

In the case of such machines, central mounting of the component 2 to be balanced or measured, with a high concentricity and repeatability as well as positioning accuracy and positioning reliability, is of particular importance, and set up times must also be kept as short as possible.

In this case, the component 2 is the tool holder 2 (with hollow shank taper interface 22), but it may also be some other tool-holding fixture for a drilling, milling or grinding tool, a rotor or some other machine component to be balanced or measured.

Balancing adapters 1, together with the machine element 8 holding them, i.e. machine spindle 8, will be referred to jointly as a clamping system, both together ensuring that the component 2 to be clamped, here the tool holder 2, can be clamped on the balancing machine 60.

Clamping system (1, 8) with balancing adapter 1 and balancing machine spindle 8 (first embodiment, FIGS. 1 to 3):

As FIGS. 1 to 3 show here, the balancing adapter 1 includes a balancing-adapter housing part 5 that can be inserted into the balancing machine/drive spindle 8 of the balancing device 60.

Component clamping (by the first clamping device 3):

This balancing-adapter housing part 5 is substantially hollow-cylindrical—with a receiving opening 45 at its upper end and a cylindrical passage 46 extending as far as its lower end.

The receiving opening 45 provides a cylindrical receiving region for a tapered shank 22 (in this case a hollow shank taper interface 22) of the tool holder 2 to be clamped or—more generally below-component 2.

The shank 22 of the component 2 to be clamped is of tapered configuration—and can have a polygonal, circular or other suitable cross section. Axially above the shank 22, the component 2 to be clamped has a supporting flange 50, which—when the component to be clamped is inserted for clamping into the receiving opening 6—rests on the upper end face of the balancing-adapter housing part 5 (and the component 2 to be clamped thus reaches/adopts its maximum penetration depth into the receiving opening 45 of the balancing adapter 1).

Provided in the region of the end of the tapered shank 22 of the component 2 is a substantially cylindrical inner axial recess 52 with an inner clamping portion 53, via which the component 2 can be clamped or held—by using the balancing adapter 1 (in form-locking engagement by virtue of the first clamping device 3 of the balancing adapter 1).

A bearing bush 21, which provides radially resilient tongues in its upper region, is inserted in the cylindrical receiving opening 45 of the balancing-adapter housing part 5.

The inner contour of the bearing bush 21 is matched to the cross section of the shank 22 of the component 2 to be clamped in such a way that-when the component 2 to be clamped is inserted into the balancing adapter 1 as far as its maximum penetration depth—the tongues are pushed radially outwards slightly—and centering insertion of the component 2 is thus facilitated or ensured.

The balancing-adapter housing part 5 also accommodates a or the first clamping device 3 including a first collet 10 and a two-part first actuating element 4, coaxial with the latter, for actuating the collet 10 (by axial movement—in the release 63 or clamping direction 64—of the first actuating element 4).

The first actuating element 4 has an upper first tie rod 15 and a lower second tie rod 16, which is coaxial with the latter, is or can be screwed to the first tie rod 15 and is guided in the balancing-adapter housing part 5, via which the first actuating element 4 (as a whole) can thus be guided in the balancing-adapter housing part 5 and moved axially—and in this way the first clamping device 3 can be actuated (i.e. clamped and released).

The first collet 10 provides a plurality of separate first clamping tongues 11, which are disposed circumferentially in a ring shape and centrically around the first actuating element 4 or first tie rod 15. Each clamping tongue 11 is seated by its respective lower end in an annular recess 54 in the cylindrical passage 46 and, in its upper region, has a front/upper first clamping region 12 assigned to the component 2 to be clamped.

First clamping claws 13—in the form of radially outer form-locking elements 14—that can clamp the component 2 are formed in the front/upper first clamping region 12 of the first clamping tongues 11 and—when clamping the component 2—they (can) engage in the inner clamping portion 53 in the tapered shank end 22 of the component 2.

The movement that releases/controls the clamping and release of the first clamping claws 13 or first clamping tongues 11 is accomplished by radially outer contact surfaces 19 on the upper first tie rod 15, the contact surfaces acting as a first guide track 18 for the first clamping tongues 11. That is to say that, by virtue of axial movement of the first actuating element 4 or upper first tie rod 15, the first contact surfaces 19 guide the first clamping tongues 11—and thus produce the clamping and release movement of the first clamping tongues 11.

As FIGS. 1 to 3 show, the first guide track 18 or the first contact surfaces 19 is/are configured in such a way that—upon contact with the first clamping tongues 11 of the first collet 10—these are moved radially, at least in some region or regions, in this case in the first front/upper clamping region 12, thereby enabling the first clamping claws 13 to be brought into the form-locking engagement with the component 2 to be clamped.

The second, lower tie rod 16 has at its lower end a knob 6, which—on its outer side-makes available clamping-function surfaces 6 for a second clamping device 7 or related second clamping tongues 28.

Formed approximately in the center of the second, lower tie rod 16 there is furthermore a supporting element 20 configured as a flange 20, which is guided in a recess 55—that widens to a diameter extending as far as the lower end of the balancing-adapter housing part 5—in the lower region of the cylindrical passage 46 of the balancing-adapter housing part 5.

A perforated disc 56—with a central aperture, through which the second, lower tie rod 16 projects from below the balancing-adapter housing part 5—is secured on the lower end of the balancing-adapter housing part 5.

The upper end of the diameter enlargement 55 in the cylindrical passage 46 of the balancing-adapter housing part 5 and the perforated disc 56 thus limit the maximum possible axial movement path of the supporting element 20—and thus simultaneously also the maximum possible axial movement path of the second, lower tie rod 16 or the first actuating element 4.

A spring element 24 is inserted in the diameter enlargement 55 in the cylindrical passage 46, between the supporting element 20 and the perforated disc 56, and the spring element is supported—towards the top—against the supporting element 20 and—towards the bottom—against the perforated disc 56 (first brace 23—see above).

Through the use of the spring force of the spring element 24, the first actuating element 4 is thus pressed—via the supporting element 20 and the lower, second tie rod 16—into the release position of the first clamping device 3, in which the first clamping claws 13 of the first collet 10 are not in engagement with the component 2 to be clamped or the latter is thus released.

Balancing adapter clamping (by the second clamping device 7):

The balancing machine/drive spindle 8 provides an (inner) balancing machine-element housing part 49, which receives the balancing adapter 2 and is rotatably mounted via rolling bearings 37, in this case ball bearings, in an (outer) drive spindle housing 36.

The spindle is driven by a hollow shaft motor 44—only diagrammatically indicated here.

This balancing machine-element housing part 49 too is substantially hollow-cylindrical—with a cylindrical receiving opening 47 for the balancing adapter 1 or the balancing-adapter housing part 5 at its upper end and a cylindrical passage 48 extending as far as its lower end.

On the outer circumference, the balancing-adapter housing part 5 is likewise of substantially cylindrical configuration and—like the component 2 to be clamped—has a supporting flange 51. The balancing adapter 1 can thus be inserted into the receiving opening 47 of the balancing machine-element housing part 49 until its supporting flange 51 rests on the end face of the balancing machine-element housing part 49.

A ball bush 39, which holds the balancing adapter 1 centered, is seated in the receiving opening 47 of the balancing machine-element housing part 49. Rolling elements of the ball bush 39 can be under a radial preload, thus giving rise to play-free centering.

The balancing machine-element housing part 49 also accommodates a second clamping device 7 including a second collet 27 and a second actuating element 9, coaxial with the latter, for actuating the second collet 27 (by axial movement of the second actuating element 9).

The second actuating element 7 is configured as a compact tie element 33 guided in the balancing machine-element housing part 49. Centering of this in the balancing machine-element housing part 49 is likewise accomplished via a ball bush 39, the rolling elements of which—under a radial preload—can ensure play-free guidance.

The second collet 27 too provides a plurality of separate second clamping tongues 28, which are disposed circumferentially in a ring shape and centrically around the second actuating element 9. At their lower ends, the second clamping tongues are pressed against the tie element 33 by using an annular spring 25.

Each clamping tongue 28 is seated by its respective lower end in an annular recess 26 on the tie element 33/second actuating element 9 and, in its upper region, has a front/upper second clamping region 29 assigned to the component 2 to be clamped, that is to say the balancing adapter 2 or the inner cylindrical passage 46 thereof.

Second clamping claws 30—in the form of radially inner form-locking elements 31 that can clamp the balancing adapter 1—are formed in the front/upper second clamping region 29 of the second clamping tongues 28 and—when clamping—they (can) grip the knob 6 on the lower end of the second, lower tie rod 16.

The movement that releases/controls the clamping and release of the second clamping claws 30 or second clamping tongues 28 is accomplished by radially inner second contact surfaces 35 in the inner cylindrical passage 48 of the balancing machine-element housing part 49, the contact surfaces acting as a second guide track 34 for the second clamping tongues 28. That is to say that, by virtue of axial movement of the second actuating element 9 or tie element 33, the second contact surfaces 35 guide the second clamping tongues 28—and thus produce the clamping and release movement of the second clamping tongues 28.

As FIGS. 1 to 3 also show, the second guide track 34 or the second contact surfaces 35 is/are configured in such a way that—upon contact with the second clamping tongues 28 of the second collet 27—these are moved radially, at least in some region or regions, in this case in the second front/upper clamping region 29, thereby enabling the second clamping claws 30 to be brought into the form-locking engagement with the knob 6 of the second tie rod 16 of the first actuating element 4.

A piston 43 of a pneumatic movement device 42 is secured on the lower end of the tie element 33 of the second actuating element 9.

Compression springs 40 are clamped between the piston 43 and the balancing machine-element housing part 49. For stable retention, the compression springs 40 are inserted into identifiable blind holes 57 in the balancing machine-element housing part 49 and in the piston 43.

Through the use of these compression springs 41, the second actuating element 9—and thus the second collet 27—is pushed (via the second actuating element 9) into its clamping position (second brace 40) (gripping the knob 6 of the first actuating element 4 or the lower end of the second tie rod 16 there).

The second collet 27 can be “released” (release position) (via the second actuating element 9) by moving the piston 43 counter to the force of the compression springs 41.

For this purpose, the piston 43 can be disposed so as to be axially movable in the balancing machine-element housing part 49 while being sealed by using a radial seal (not denoted specifically), and can be subjected to compressed air (or some other pressurized fluid) from the underside.

As FIGS. 1 to 3 furthermore also show, a—mechanical—holding and/or locking device 38 secured on the drive spindle housing 36 is furthermore also provided, using which device the balancing adapter 1 can be held locked in the balancing machine-element housing part 49—and thus held in the balancing machine-element housing part 49—even when the second clamping device 7 is released.

### MODE OF OPERATION

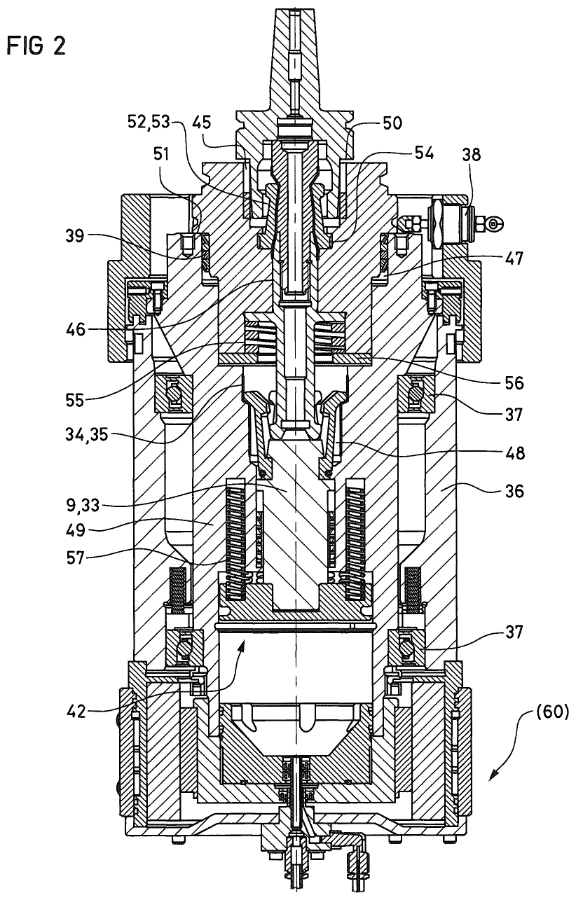

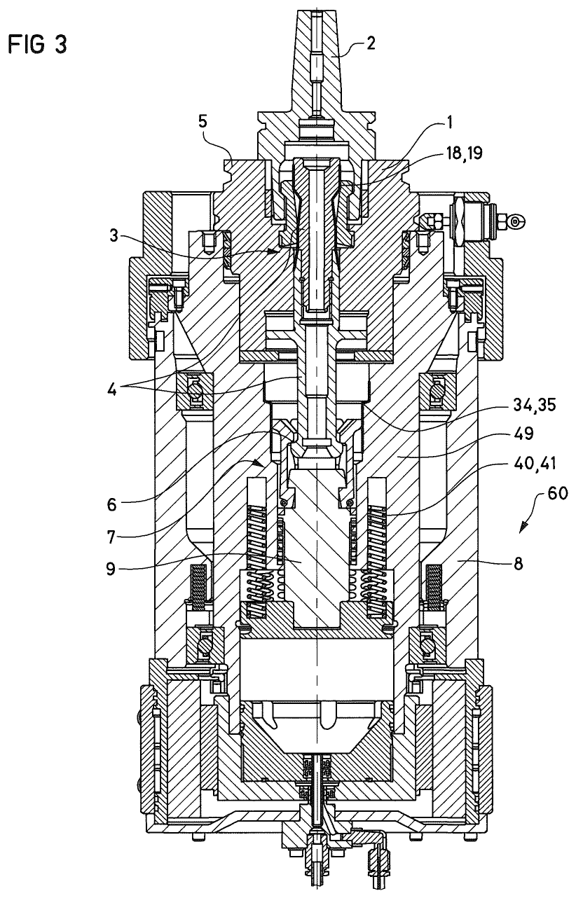

The mode of operation of the balancing adapter 1 described above is explained below (NB: FIG. 1 shows the balancing adapter 1 in its release position; FIG. 2 shows the balancing adapter 1 in an intermediate position; FIG. 3 shows the balancing adapter 1 in its clamping position):

Through the use of the piston 43 acted upon, for example, by compressed air or some other pressurized fluid, the second actuating element 9 and—under pressure via the upper end face of the tie element 33 of the second clamping device 7 or second actuating element 9—the first actuating element 4 are pushed upwards (in the release position according to FIG. 1).

In the release position shown (FIG. 1), the second collet 27 is in the released state, wherein the front/upper second clamping regions 29 of the second collet 27 are thus tilted radially outwards—and release the knob 6 on the lower end of the second tie rod 16 of the first actuating element 4. That is to say that there is no—form-locking—engagement here of the second form-locking elements 31 of the second clamping tongues 28 with the clamping-function surfaces 6 on the knob 6 at the lower end of the second tie rod 16 of the first actuating element 4.

The first actuating element 4 is thus also likewise in the release position—with the stop element 20 of the second tie rod 16 pressed by spring force against the stop in the cylindrical passage 46 of the balancing-adapter housing part 5 (here, as FIGS. 1 to 3 show, the balancing adapter 1 is held in the balancing machine-element housing part 49 by using the holding and/or locking device 38)—where the front/upper first clamping regions 12 of the first collet 10 are thus tilted radially inwards—and the component 2 to be clamped is released.

That is to say that here there is no—form-locking—engagement of the first form-locking elements 14 of the first clamping tongues 11 with the inner clamping portion 53 in the cylindrical inner axial recess 52 of the balancing adapter 1.

When the force acting on the piston 43 from below slackens, the second actuating element 9 is moved downwards by using the compression springs 41 clamped between the balancing machine-element housing part 49 and the piston 43.

As a result, the front, second clamping regions 29 on the free front end of the resilient second clamping tongues 28 of the second collet 27 slide along the second guide/contact surfaces 35 or second track 34, whereby the front ends of the resilient second clamping tongues 28 are pushed radially inwards against the knob 6 of the second tie rod 16—and grip it (FIG. 2).

The first collet 10 is still open (the first actuating element 4, since not yet gripped, has not yet been pulled axially downwards (out of its release position))—and the component 2 to be clamped is still free.

That is to say that, in this first clamping phase, only the second collet 27 is initially actuated/closed—and the coupling of the second 9 to the first actuating element 4 is thus brought about. Thus—given further axial movement of the second actuating element 9, the first actuating element 4 can now also be taken along (together with the second (coupled) actuating element 9).

Now also, the holding and/or locking device 38 can be released (cf. FIG. 2) (if—due to the coupling of the two actuating elements 4, 9—the balancing adapter 1 is secured against accidentally falling out).

With increasing axial movement of the second actuating element 9—the first actuating element 4 is now taken along axially downwards together with the second actuating element 9—the first collet 10 is then also closed (second clamping phase, cf. FIG. 3).

That is to say that here the first clamping tongues 11 of the first collet 10—guided by the first track 18 or first guiding surfaces 19—are now pushed radially outwards, and the first collet 10 grips. The component 2 to be clamped is gripped.

With further increasing axial movement of the two actuating elements 4, 9, the component 2 to be clamped and the balancing adapter 1 are pulled in as far as their maximum retraction (clamping position) (axially counter to the force of the (two) compression springs 24, 41)—and thus are both held clamped (cf. FIG. 3).

By the application of pressure to the piston 43, the release process can be performed in the opposite sense, in which case the holding and/or locking device 38 can then also be locked here at the end of the release process (cf. FIG. 1).

The—now “unclamped” or released—component 2 can simply be removed. The balancing adapter 1 remains held—by the holding and/or locking device 38.

Clamping system (1, 8) with balancing adapter 1 and balancing machine spindle 8 (second embodiment, FIGS. 4 to 5):

The balancing adapter 1 according to this second embodiment is of substantially identical construction to the first balancing adapter 1 described above (cf. FIGS. 1 to 3). (Components of identical construction are shown by the figures and are not repeated in order to avoid repetition).

As a significant difference from the first balancing adapter 1 (cf. FIGS. 1 to 3), the first brace 23 in the case of the (second) balancing adapter 1 (cf. FIGS. 4 to 5) is formed in the balancing adapter 1—that is to say here as a preload 23 directed counter to the release or release actuation/release actuation direction.

It preloads the first clamping device 3—and can thus ensure that—even when the second actuating element 9 is in the release position—the first clamping device 3 continues to be clamped—and the component 2 to be clamped remains clamped/held on the balancing adapter 1.

Component 2 and balancing adapter 1 form as it were a (preloaded) unit and—as a preloaded (joint) clamping set—can be changed/fitted as a unit.

For this purpose, as FIGS. 4 to 5 show, a compression spring 24 (accommodated in blind holes 57) can be inserted between the supporting element 20 and the balancing-adapter housing part 5 in such a way that the first actuating element 4 is pushed axially downwards away from the balancing-adapter housing part 5—and the first collet 10 is thus actuated or closed. The component 2 already inserted into the balancing adapter 1 can thus be preloaded in the balancing adapter 1.

Also as a departure from the first balancing adapter 1 (cf. FIGS. 1 to 3), the balancing adapter 1, as FIGS. 4 to 5 show, does not provide a holding and/or locking device 38 in this case. Here, the balancing adapter 1 is held in the balancing machine-element housing part 49 “only”/solely via the second clamping device 7.

### MODE OF OPERATION

The mode of operation of the balancing adapter 1 described above is explained below (NB: FIG. 4 shows the balancing adapter 1 in its release position; FIG. 5 shows the balancing adapter 1 in its clamping position):

Here too, Through the use of the piston 43 acted upon, for example, by compressed air or some other pressurized fluid, the second actuating element 9 is pushed upwards.

In the release position shown (FIG. 4), the second collet 27 is in the released state, wherein the front/upper second clamping regions 29 of the second collet 27 are thus tilted radially outwards—and release the knob 6 on the lower end of the second tie rod 16 of the first actuating element 4.

That is to say that there is no—form-locking—engagement here of the second form-locking elements 31 of the second clamping tongues 28 with the clamping-function surfaces 6 on the knob 6 at the lower end of the second tie rod 16 of the first actuating element 4.

Here-due to the spring force of the first brace 23 (preload)—the first actuating element 4 is in the clamping position, where the front/upper first clamping regions 12 of the first collet 10 are thus tilted radially outwards—and clamp the component 2 to be clamped on the balancing adapter 1.

That is to say that here there is—form-locking—engagement of the first form-locking elements 14 of the first clamping tongues 11 with the inner clamping portion 53 in the cylindrical inner axial recess 52 of the balancing adapter 1.

The component 2 to be clamped and the balancing adapter 1 form the preloaded clamping set.

When the force acting on the piston 43 from below slackens, the second actuating element 9 is moved downwards by the compression springs 41 clamped between the balancing machine-element housing part 49 and the piston 43.

As a result, the front, second clamping regions 29 on the free front end of the resilient second clamping tongues 28 of the second collet 27 slide along the second guide/contact surfaces 35 or second track 34, whereby the front ends of the resilient second clamping tongues 28 are pushed radially inwards against the knob 6 of the second tie rod 16—and grip it (FIG. 5). The coupling of the second 9 to the first actuating element 4 has taken place.

With further increasing axial movement—now of the two actuating elements 4, 9—the component 2 to be clamped and the balancing adapter 1 are pulled in as far as their maximum retraction (clamping position)—and thus are both held clamped (cf. FIG. 5).

By the application of pressure to the piston, the release process can be performed in the opposite sense.

Although the invention has been illustrated and described more specifically in detail by the preferred exemplary embodiments, the invention is not restricted by the examples disclosed, and other variations can be derived therefrom without exceeding the scope of protection of the invention.

The following is a summary list of reference numerals and the corresponding structure used in the above description of the invention:
1 balancing or measuring adapter, clamping adapter
2 component (to be clamped), tool holder, workpiece
3 first clamping device
4 first actuating element
5 (clamping/balancing-adapter) housing part
6 clamping-function surfaces, knob or outer surface of the knob
7 second clamping device
8 machine element, balancing machine/drive spindle
9 second actuating element
10 first collet
11 first clamping tongues
12 first clamping region
13 first clamping claw
14 form-locking element (of the first clamping claws)
15 first actuating sub-element (of the first actuating element), first tie rod
16 second actuating sub-element (of the first actuating element), second tie rod
18 first (guide) track
19 first contact surfaces (on the first (guide) track)
20 stop/supporting element, flange
21 centering element, ball bush, bearing bush
22 hollow shank taper/tapered interface, (tapered) shank
23 first brace
24 bracing element, spring element, compression spring (of 23)
25 annular spring
26 (annular) recess (on 33)
27 second collet
28 second clamping tongues
29 second clamping region
30 second clamping claw
31 form-locking element (of the second clamping claws)
33 actuating sub-element (of the second actuating element), tie element
34 second (guide) track
35 second contact surfaces (on the second (guide) track)
36 machine-element housing, machine spindle housing
37 rolling bearing
38 (mechanical) holding and/or locking device
39 second centering element, ball/bearing bush, ball cage
40 second brace
41 bracing element, spring element, compression spring (of 40)
42 (mechanical, pneumatic, hydraulic) (movement) device
43 piston (of 42)
44 drive unit, hollow shaft motor
45 (cylindrical) receiving opening (of 5)
46 (cylindrical) passage (of 5)
47 (cylindrical) receiving opening (of 49)
48 (cylindrical) passage (of 49)
49 ((balancing) machine element) housing part
50 supporting flange (of 2)
51 supporting flange (of 1)
52 axial recess
53 (inner) clamping portion
54 annular recess (in 46)
55 recess/diameter enlargement (in 5)
56 perforated disc
57 blind hole
60 machine element, balancing or measuring machine, balancing device, measuring device, device for manufacturing and/or shaping a component
61 axial, axial direction
62 radial, radial direction
63 release direction
64 pull-in/clamping direction

1. A clamping adapter for clamping a component, the clamping adapter comprising:
a clamping-adapter housing part;
a first clamping device mounted in said clamping-adapter housing part and configured to clamp the component;
a second clamping device of a machine element of a machine for at least one of processing or measuring;
a first actuating element configured to actuate said first clamping device; and
a second actuating element;
said first actuating element having clamping-function surfaces for coupling or releasing said first actuating element to or from said second actuating element by using said second clamping device and said second clamping device being actuated upon actuating said second actuating element;
said first actuating element configured to then be actuated by said second actuating element and, upon said second actuating element being actuated, the clamping adapter also being clamped on or released from said machine element.

2. The clamping adapter according to claim 1, wherein said first clamping device has a first collet with at least one of a first sleeve-shaped base or a plurality of radially resilient first clamping tongues separated from one another in a circumferential direction by axial slots, attached to said first sleeve-shaped base and having a front, first clamping region associated with the component to be clamped or with a plurality of separate first clamping tongues configured to be distributed in the circumferential direction and have a front, first clamping region associated with the component to be clamped.

3. The clamping adapter according to claim 2, wherein said sleeve-shaped base or said separate clamping tongues are being held in said clamping-adapter housing part.

4. The clamping adapter according to claim 1, which further comprises first clamping claws configured to clamp the component, said first clamping claws being formed in said front, first clamping region of said first clamping tongues or of said first collet.

5. The clamping adapter according to claim 4, wherein said first clamping claws have radially outer form-locking elements.

6. The clamping adapter according to claim 1, wherein said first actuating element has a multi-part configuration with a plurality of actuating sub-elements configured to be connected to one another or screwed together and configured as tie rods.

7. The clamping adapter according to claim 1, wherein said first actuating element or said actuating sub-elements or tie rods of said first actuating element are mounted in said clamping-adapter housing part in such a way as to be movable relative to said clamping-adapter housing part and axially.

8. The clamping adapter according to claim 2, wherein said actuating sub-elements include a first actuating sub-element having radially outer contact surfaces for guiding said first clamping device or said first clamping tongues of said first collet and for acting as a first guide track for said first clamping device or said first clamping tongues of said first collet.

9. The clamping adapter according to claim 8, wherein said first guide track or said first contact surfaces are configured to be radially moved upon contact with said first clamping tongues of said first collet at least in some region or regions in said first clamping region, thereby enabling said first clamping claws to be brought into form-locking engagement with the component to be clamped.

10. The clamping adapter according to claim 8, wherein said actuating sub-elements include a second actuating sub-element having an end region forming said clamping-function surfaces configured as a knob or configured on an outer surface of a knob.

11. The clamping adapter according to claim 10, wherein said second actuating sub-element has a stop element configured to be brought into contact with said clamping-adapter housing part when said first actuating element is actuated and to move said clamping-adapter housing part axially.

12. The clamping adapter according to claim 1, which further comprises a first sleeve-shaped centering element mounted in a receiving opening of said clamping-adapter housing part, for centered mounting of the component to be clamped or of an entire tool having a conical interface, on the clamping adapter.

13. The clamping adapter according to claim 1, which further comprises a first brace having a bracing element or spring element bracing said first actuating element against said clamping-adapter housing part.

14. The clamping adapter according to claim 13, wherein said bracing element or spring element is disposed functionally for acting between said first actuating element and said clamping-adapter housing part.

15. The clamping adapter according to claim 13, wherein said first brace has a first bracing force selected in accordance with the component to be clamped.

16. A machine element for clamping a clamping adapter according to claim 1 configured to clamp a component to a machine-element housing part, the machine element comprising:
a first actuating element of a first clamping device of the clamping adapter configured to clamp the component;
a second clamping device mounted in the machine-element housing part, said second clamping device being used for clamping or releasing said first actuating element;
a second actuating element configured to actuate said second clamping device and to then actuate said first actuating element by using said second clamping device and, upon said second actuating element being actuated, the clamping adapter also being clamped on or released from the machine element.

17. The machine element according to claim 16, wherein:
said first clamping device has a first collet with at least one of a first sleeve-shaped base or a plurality of radially resilient first clamping tongues separated from one another in a circumferential direction by axial slots, attached to said first sleeve-shaped base and having a front, first clamping region associated with the component to be clamped or with a plurality of separate first clamping tongues configured to be distributed in the circumferential direction and have a front, first clamping region associated with the component to be clamped; and
said second clamping device has a second collet with at least one of a second sleeve-shaped base or a plurality of radially resilient second clamping tongues separated from one another in a circumferential direction by axial slots, attached to a first sleeve-shaped base and having a front, second clamping region associated with said first actuating element to be clamped or with a plurality of separate second clamping tongues configured to distributed in the circumferential direction and having a front, second clamping region associated with said first actuating element to be clamped.

18. The machine element according to claim 17, which further comprises second clamping claws configured to clamp said first actuating element, said second clamping claws having form-locking elements formed in said front, second clamping region for form-locking to said clamping-function surfaces of said first actuating element.

19. The machine element according to claim 17, which further comprises a load application element or an annular spring holding and bracing said second clamping tongues against said second actuating element.

20. The machine element according to claim 16, wherein said second actuating element has a multi-part configuration with a plurality of actuating sub-elements configured to be connected to one another or screwed together.

21. The machine element according to claim 17, wherein the machine-element housing part has second contact surfaces for guiding said second clamping device or said second clamping tongues of said second collet, said second contact surfaces being radially inner contact surfaces acting as a second guide track for said second clamping device or said second clamping tongues of said second collet.

22. The machine element according to claim 21, wherein said second guide track or said second contact surfaces are configured to be moved radially, at least in some region or regions or in said second clamping region, upon contact with the second clamping tongues of said second collet, enabling said second clamping claws to be brought into form-locking engagement with said clamping-function surfaces of said first actuating element.

23. The machine element according to claim 16, wherein said second actuating element is mounted in the machine-element housing part movably relative to the machine-element housing part and axially.

24. The machine element according to claim 16, which further comprises a machine-element housing in which said machine-element housing part is rotatably received or mounted by rolling bearings.

25. The machine element according to claim 24, which further comprises at least one of:
a device for at least one of holding or locking the clamping adapter in the machine-element housing part, or
a screwed joint for screwing the clamping adapter to the machine-element housing part.

26. The machine element according to claim 25, wherein said device for at least one of holding or locking is secured on said machine-element housing or on the machine-element housing part.

27. The machine element according to claim 25, wherein said device for at least one of holding or locking is mechanically actuatable and during actuation permits the clamping adapter to be held and locked by form-locking in the machine-element housing part.

28. The machine element according to claim 16, which further comprises a second centering element or ball cage mounted in a receiving opening of the machine-element housing part, for centered mounting of the clamping adapter on the machine element.

29. The machine element according to claim 20, which further comprises:
a first brace having a bracing element or spring element bracing said first actuating element against said clamping-adapter housing part; and
a second brace acting with or counter to said first brace, said second brace having a bracing element or a spring element or compression spring bracing said second actuating element or said second actuating sub-element against the machine-element housing part.

30. The machine element according to claim 29, wherein said bracing element or spring element of said second brace is disposed functionally for acting between said second actuating element or said second actuating sub-element and the machine-element housing part.

31. The machine element according to claim 29, wherein said first brace has a first bracing force and said second brace has a second bracing force being matched to one another in consideration of the component to be braced.

32. The machine element according to claim 31, wherein said first bracing force of said first brace and said second bracing force of said second brace are configured to act in an identical direction.

33. The machine element according to claim 31, wherein said first bracing force of said first brace and said second bracing force of said second brace are configured to counteract one another.

34. The machine element according to claim 29, which further comprises a device mounted in the machine-element housing part and configured to be operated pneumatically or hydraulically or mechanically for moving said second actuating element for at least one of clamping or releasing.

35. The machine element according to claim, 34 wherein said device configured to be operated pneumatically or hydraulically or mechanically moves said second actuating element in a controlled manner.

36. The machine element according to claim 34, wherein said second brace and said device configured to be operated pneumatically or hydraulically or mechanically are configured and matched to one another to cause a pneumatically or hydraulically or mechanically applied movement force to act counter to said second bracing force.

37. A clamping system according to claim 16 for clamping the component on the machine element of a machine for at least one of processing or measuring, the clamping system comprising:
said first actuating element being coupled to or released from said second actuating element, causing both the component in the clamping adapter and the clamping adapter on said machine element to be clamped or released upon actuating said second actuating element.

38. A clamping system according to claim 16 for clamping the component on the machine element of a machine for at least one of processing or measuring, the clamping system comprising:
said first actuating element configured to be coupled to said second actuating element, causing both said first actuating element and said second actuating element to be actuated and moved axially and causing the component to be clamped on the clamping adapter by said first clamping device, upon actuation of said second actuating element.

39. A clamping system according to claim 16 for clamping the component on the machine element of a machine for at least one of processing or measuring, the clamping system comprising:
both the component in the clamping adapter and the clamping adapter on the machine element configured to be clamped or released upon said second actuating element being actuated.

40. A clamping system according to claim 16 for clamping the component on the machine element of a machine for at least one of processing or measuring, the clamping system comprising:
both said first actuating element and said second actuating element configured to be actuated and moved axially, causing the component to be clamped on the clamping adapter by using said first clamping device, upon said second actuating element being actuated.

41. A machine for at least one of processing or measuring a component with a clamping adapter or a machine element according to claim 37, the machine comprising:
the component configured to be clamped on the machine element of the processing machine during at least one of processing or measurement, by using the clamping adapter or the clamping system.

42. A method for clamping or releasing a component on a machine element of a machine for at least one of processing or measuring according to claim 41 by using a clamping mechanism, the method comprising:
during the clamping or releasing of the component on the clamping adapter by actuation of the clamping mechanism, additionally clamping or releasing the clamping adapter on the machine element of the processing machine by the actuation of the clamping mechanism.

43. A method for clamping or releasing a component on a machine element of a machine for at least one of processing or measuring according to claim 41 by using a first clamping mechanism configured to be actuated by a first actuating element, and by using a second clamping mechanism configured to be actuated by a second actuating element, the method comprising:
coupling said first actuating element to said second actuating element by actuation of said second actuating element; and
then upon actuating said second actuating element, both said first actuating element and said second actuating element being actuated and moved axially, causing the component to be clamped on the clamping adapter by the first clamping mechanism.

44. The method for clamping or releasing a component according to claim 42, which further comprises sequentially carrying out the clamping and releasing of the clamping adapter and of the component during the actuation of the clamping mechanism and during the actuation of said second actuating element.

45. The method for clamping or releasing a component according to claim 42, which further comprises simultaneously carrying out the clamping and releasing of the clamping adapter and of the component during the actuation of the clamping mechanism and during the actuation of said second actuating element.

46. The method for clamping or releasing a component according to claim 42, which further comprises using a brace to prevent the release of the component clamped on the clamping adapter during the actuation of the clamping mechanism and during the actuation of said second actuating element.

47. The method for clamping or releasing a component according to claim 42, which further comprises, during the actuation of the clamping mechanism and during the actuation of said second actuating element, at least one of moving the component axially relative to the clamping-adapter housing part or moving the clamping adapter axially relative to the machine-element housing part.

48. The method for clamping or releasing a component according to claim 42, which further comprises, during clamping by actuation of said second actuating element caused by axial movement of said second actuating element relative to the machine-element housing part in a pull-in/clamping direction, using said second clamping device to clamp or grip said first actuating element in a first clamping phase.

49. The method for clamping or releasing a component according to claim 48, which further comprises, during clamping by actuation of said second actuating element caused by axial movement of said second actuating element relative to the machine-element housing part in the pull-in/clamping direction, then in a second clamping phase following the first clamping phase, also moving said first actuating element clamped by said second clamping device axially in the pull-in/clamping direction of said second actuating element.

50. The method for clamping or releasing a component according to claim 49, which further comprises, in the second clamping phase, using said first clamping device actuated by said first actuating element to clamp the component to be clamped on the clamping adapter and then, by further actuation of said second actuating element by axial movement of said second actuating element relative to the machine-element housing part in the pull-in/clamping direction, clamping the clamping adapter on the machine element.

51. The method for clamping or releasing a component according to claim 49, which further comprises, pre-bracing the component to be clamped on the clamping adapter by said first clamping device in the second clamping phase, and then only clamping the clamping adapter on the machine element.

52. The method for clamping or releasing a component according to claim 42, which further comprises, during release by actuation of said second actuating element by axial movement of said second actuating element relative to the machine-element housing part in a release direction, moving said first actuating element and said second actuating element axially in the release direction, resulting in initially only the component clamped on the clamping adapter being released or freed and only then releasing or feeing the clamping adapter clamped on the machine element.

53. The method for clamping or releasing a component according to claim 42, which further comprises, during release by actuation of said second actuating element by axial movement of said second actuating element relative to the machine-element housing part in a release direction, moving said second actuating element in the release direction, resulting in the clamping adapter clamped on the machine element being released or freed.
